(19) United States
(12) Patent Application Publication
(10) Pub. No.: US 2010/0294579 A1
(43) Pub. Date: Nov. 25, 2010

(54) AUTO-CHARGING POWER DEVICE AND ELECTRIC VEHICLE WITH AUTO-CHARGING POWER DEVICE

(76) Inventor: Fei-Neng CHEN, Taipei (TW)

Correspondence Address: PATENTTM.US, P. O. BOX 82788, PORTLAND, OR, 97282-0788, US

(21) Appl. No.: 12/471,447

(22) Filed: May 25, 2009

(51) Int. Cl. B60K 25/00

(52) U.S. Cl. 180/65.31

(57) ABSTRACT

An auto-charging power device is mounted in an electric vehicle and has a generator and a motor connected to two opposite ends of a driving shaft and a battery connected to the generator and the motor. The driving shaft of the auto-charging power device may be coaxially connected to and be implemented as an axle of the electric vehicle. The battery drives the motor, the motor drives the driving shaft and the driving shaft drives the generator to generate and store electricity in the battery. Therefore, the battery remains charged for a long time and range of the electric vehicle is extended. The auto-charging power device is environmental friendly and energy saving.

### BACKGROUND OF THE INVENTION

1. Field of the Invention

The present invention relates to a power device and an electric vehicle with the power device, especially to a auto-charging power device.

2. Description of the Prior Art(s)

A conventional electric vehicle comprises a body, two front wheels and two rear wheels mounted on a bottom of the body, and a motor, a battery and a transmission mounted in the body. The motor is powered by the battery, is connected to the front wheels or the rear wheels through the transmission to drive the conventional vehicle forward.

Although the conventional electric vehicles do not burn gasoline, do not emit exhaust gases and are more environmental friendly than gasoline vehicles, recharging the battery is inconvenient and takes time. Thus, range and convenience of conventional electric vehicles are inferior to gasoline vehicles. Even though electric vehicles are promoted and subsidized, conventional electric vehicles are still not popular.

To overcome the shortcomings, the present invention provides a auto-charging power device and an electric vehicle with the auto-charging power device to mitigate or obviate the aforementioned problems.

### SUMMARY OF THE INVENTION

The main objective of the present invention is to provide an auto-charging power device and an electric vehicle with the auto-charging power device.

The auto-charging power device is mounted in the electric vehicle and has a generator and a motor connected to two opposite ends of a driving shaft and a battery connected to the generator and the motor. The driving shaft of the auto-charging power device may be coaxially connected to an axle of the electric vehicle and may be implemented as the axle of the electric vehicle. The battery drives the motor, the motor drives the driving shaft and the driving shaft drives the generator to generate and store electricity in the battery.

Therefore, the battery remains charged for longer and range of the electric vehicle is extended. The auto-charging power device is environmental friendly and energy saving

Other objectives, advantages and novel features of the invention will become more apparent from the following detailed description when taken in conjunction with the accompanying drawings.

### BRIEF DESCRIPTION OF THE DRAWINGS

FIG. 1 is a schematic view of an auto-charging power device in accordance with the present invention, showing a connection between a generator, a motor and a battery; and

FIG. 2 is an operational schematic view of an electric vehicle with the auto-charging power device in accordance with the present invention.

### DETAILED DESCRIPTION OF THE PREFERRED EMBODIMENTS

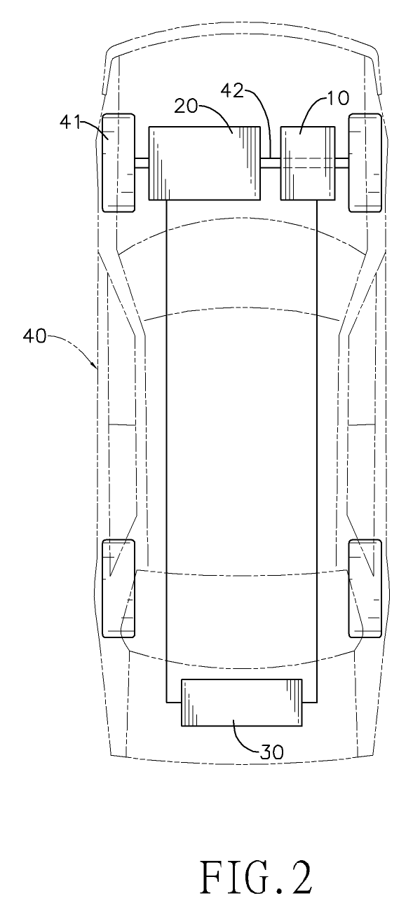

With reference to FIG. 2, an electric vehicle (40) in accordance with the present invention has a bottom, a front end, a rear end, two front wheels (41), two rear wheels and an axle (42). The front wheels (41) are mounted rotatably on the bottom of the electric vehicle (40) adjacent to the front end of the electric vehicle (40). The rear wheels are mounted rotatably on the bottom of the electric vehicle (40) adjacent to the rear end of the electric vehicle (40). The axle (42) has two opposite ends. The ends of the axle (42) are connected respectively to the front wheels (41) and may be connected respectively to the rear wheels.

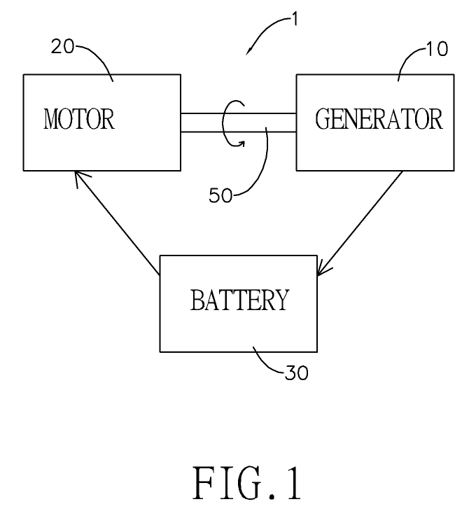

With further reference to FIG. 1, an auto-charging power device (1) for an electric vehicle in accordance with the present invention is mounted in the electric vehicle (40) and comprises a driving shaft (50), an optional transmission assembly, a generator (10), a motor (20) and a battery (30).

The driving shaft (50) may be coaxially connected to the axle (42), may be implemented as the axle (42) and has an input end and an output end.

The transmission assembly is connected to the driving shaft (50) and has an output end and an input end. The output end of the transmission assembly is connected to the input end of the driving shaft (50).

The generator (10) is connected to the output end of the driving shaft (50).

The motor (20) is connected to the input end of the driving shaft (50) and may be connected to the input end of the transmission assembly.

The battery (30) is connected to and is charged by the generator (10), supplies electricity to the motor (20) and has an output end and an input end. The output end of the battery (30) is connected to the motor (20). The input end of the battery (30) is connected to the generator (10).

Thus, the battery (30) drives the motor (20), the motor (20) drives the driving shaft (50), the axle (42) and the wheels (41) to drive the electric vehicle (40) forward. Meanwhile, the driving shaft (50) also drives the generator (10) to generate power to charge the battery (30).

The auto-charging power device (1) and an electric vehicle (40) with the auto-charging power device (1) as described is environmental friendly and energy saving and has the following advantages. The motor (20) is powered by the battery (30) and drives the generator (10) through the driving shaft (50). Output current of the battery (30) is about 40 ampere. The motor (20) consumes about 10 to 20 ampere of the current. The generator (10) consumes about 10 to 20 ampere of the current and generates a current of about 5 to 10 ampere. The current generated by the generator (10) is stored in the battery (30). Consequently, the battery (30) remains powerful for a long time and range of the electric vehicle is extended.

Even though numerous characteristics and advantages of the present invention have been set forth in the foregoing description, together with details of the structure and features of the invention, the disclosure is illustrative only Changes may be made in the details, especially in matters of shape, size, and arrangement of parts within the principles of the invention to the full extent indicated by the broad general meaning of the terms in which the appended claims are expressed.

What is claimed is:

1. An auto-charging power device comprising:
a driving shaft having
an input end; and
an output end;
a generator connected to the output end of the driving shaft;
a motor connected to the input end of the driving shaft; and
a battery connected to and charged by the generator, supplying electricity to the motor and having
an output end connected to the motor; and
an input end connected to the generator;
whereby the battery drives the motor, the motor drives the driving shaft and the driving shaft drives the generator to generate electricity to charge the battery.

2. An electric vehicle with an auto-charging power device as claimed in claim 1 comprising:
a bottom;
a front end;
a rear end;
two front wheels mounted rotatably on the bottom of the electric vehicle adjacent to the front end of the electric vehicle;
two rear wheels mounted rotatably on the bottom of the electric vehicle adjacent to the rear end of the electric vehicle;
an axle having two opposite ends connected respectively to the front wheels;
the auto-charging power device mounted in the electric vehicle; and
the driving shaft of the auto-charging power device coaxially connected to the axle.

3. An electric vehicle with an auto-charging power device as claimed in claim 1 comprising:
a bottom;
a front end;
a rear end;
two front wheels mounted rotatably on the bottom of the electric vehicle adjacent to the front end of the electric vehicle;
two rear wheels mounted rotatably on the bottom of the electric vehicle adjacent to the rear end of the electric vehicle;
an axle having two opposite ends connected respectively to the front wheels;
the auto-charging power device mounted in the electric vehicle; and
the driving shaft of the auto-charging power device implemented as the axle.
